(19) United States
(12) Patent Application Publication
(10) Pub. No.: US 2015/0331615 A1
(43) Pub. Date: Nov. 19, 2015

(54) MULTI-ELEMENT SOLID-STATE STORAGE DEVICE MANAGEMENT

(71) Applicant: EMPIRE TECHNOLOGY DEVELOPMENT LLC, Wilmington, DE (US)

(72) Inventor: Ezekiel Kruglick, Poway, CA (US)

(21) Appl. No.: 14/354,491

(22) PCT Filed: Nov. 20, 2012
(86) PCT No.: PCT/US12/66054

§ 371 Date: Apr. 25, 2014

(51) Int. Cl. G06F 3/06

(52) U.S. Cl. CPC G06F 3/0611; G06F 3/0613; G06F 3/0659; G06F 3/0685

(57) ABSTRACT

The present disclosure describes various techniques related to control of solid state drives.

### BACKGROUND

Storage strategies for spinning disks may not be suitable for solid-state drives (SSDs). More particularly, storage strategies for multi-element spinning disk storage arrays may not apply to multi-element solid-state storage arrays. For example, redundant array of independent disks (RAID) storage controllers designed for spinning disk storage may not be optimized for solid-state storage. Storage strategies (e.g., striping, or the like) may not be beneficial to SSD RAID configurations. Furthermore, issues such as Flash bus contention, congestion, and throughput may negate many of the performance improvements seen from using storage strategies optimized for spinning disks. Additionally, such issues may cause the overall throughput to a multi-element storage array to be less than if the SSDs were used separately.

### SUMMARY

Detailed herein are various illustrative methods for data storage management, which may be embodied as any variety of methods, apparatus, systems and/or computer program products.

Some example methods may include at a first solid state storage device controller, receiving an indication of an event affecting performance of a first solid state storage device, and responsive to the received indication, transmitting an instruction from the first solid state storage device controller to a second solid state storage device controller, the instruction configured to facilitate compensation for the event affecting performance of the first solid state storage device by a second solid state storage device based at least in part on the received indication.

Additional example methods may include at a memory control module, receiving an indication of an event affecting performance of a first solid state storage device from a first solid state storage device controller, and responsive to the received indication, transmitting an instruction to a second solid state storage device controller, the transmitted instruction configured to facilitate compensation for the event affecting performance of the first solid state storage device by a second solid state storage device based at least in part on the received indication.

The present disclosure also describes various example machine-readable non-transitory medium having stored therein instructions that, when executed by one or more processors, operatively enable a data storage management between a first solid-state storage device and a second solid-state storage device. Example machine-readable non-transitory media may have stored therein instructions that, when executed by one or more processors, operatively enable a first solid state storage device controller to receive an indication of an event affecting performance of a first solid state storage device, and responsive to the received indication, transmit an instruction from the first solid state storage device controller to a second solid state storage device controller, the instruction configured to facilitate compensation for the event affecting performance of the first solid state storage device by a second solid state storage device based at least in part on the received indication.

Another example machine-readable non-transitory medium may have stored therein instructions that, when executed by one or more processors, operatively enable a memory control module to receive an indication of an event affecting performance of a first solid state storage device from a first solid state storage device controller, and responsive to the received indication, transmit an instruction to a second solid state storage device controller, the transmitted instruction configured to facilitate compensation for the event affecting performance of the first solid state storage device by a second solid state storage device based at least in part on the received indication.

The present disclosure additionally describes example systems, which may include a first solid state storage device,a first solid state storage device controller, the first solid state storage device controller communicatively coupled to the first solid state storage device, a second solid state storage device, and a second solid state storage device controller, the second solid state storage device controller communicatively coupled to the second solid state storage device and to the first solid state storage device controller, wherein the first solid state storage device controller being configured to receive an indication of an event affecting performance of the first solid state storage device, and responsive to the received indication, transmit an instruction from the first solid state storage device controller to the second solid state storage device controller, the instruction configured to facilitate compensation for the event affecting performance of the first solid state storage device by the second solid state storage device based at least in part on the received indication.

Additional example systems may include a first solid state storage device, a first solid state storage device controller, the first solid state storage device controller communicatively coupled to the first solid state storage device, a second solid state storage device, a second solid state storage device controller, the second solid state storage device controller communicatively coupled to the second solid state storage device and to the first solid state storage device controller, and a memory control module, the memory control module being configured to receive an indication of an event affecting performance of the first solid state storage device from the first solid state storage device controller, and responsive to the received indication, transmit an instruction to the second solid state storage device controller, the transmitted instruction configured to facilitate compensation for the event affecting performance of the first solid state storage device by the second solid state storage device based at least in part on the received indication.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of an example solid-state storage device system;

FIG. 2 illustrates a block diagram of another example solid-state storage device system;

FIG. 3 illustrates a flow chart of an example method for managing writing data to a multi-element solid-state storage array;

FIG. 4 illustrates a flow chart of another example method for managing writing data to a multi-element solid-state storage array;

FIG. 5 illustrates an example computer program product;

FIG. 6 illustrates another example computer program product; and

FIG. 7 illustrates a block diagram of an example computing device, all arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and/or computer program products related to managing data storage in multi-element solid-state storage systems.

Data storage strategies applicable to multiple element storage arrays (e.g., RAID configurations, JBOD configurations, or the like) may be configured to split the data stream into queues in order to facilitate writing the data to the elements in the storage array. For example, when data is written to a two-element RAID array, the data may be split into two queues. A first queue for the first storage element in the RAID array and a second queue for the second storage element in the RAID array. Data may be divided evenly between the two queues, in a symmetric manner. As such, the overall write rate to the RAID array may correspond to the slowest write rate of either of the two devices in the RAID array.

Contention and congestion issues experienced by solid-state storage devices (SSDs) may be related to the physical location of data placement within the solid-state storage elements. The physical location of data placement may itself be dependent upon various events (e.g., TRIM, wear leveling, non-duplication of data, or the like). As such, each solid-state storage device (SSD) has a statistically worst-case data write rate. Accordingly, as can be appreciated in light of the present disclosure, the overall data write rate for a multi-element solid-state storage device array may need to be slowed to correspond to the slowest statistically possible worst-case write rate associated with the solid-state storage devices in the array.

Various embodiments are described herein that may allow storage devices in a multi-element storage array to service input data when they are available. More particularly, a device may service input data as that device has available resources to process data. For example, the devices in the multi-element storage array may process data from a shared input data queue. A device may process data from the queue as that device is available. Utilizing a shared input data queue and allowing processing as each device has available bandwidth may allow the data to be processed faster than if the data was symmetrically split into queues for each device as described above.

With some embodiments described herein, multiple elements in a storage array may process data from a single input queue. For example, using the two-element RAID array introduced above, a main input data queue may be provided. Each device in the RAID array may be configured to access the main input data queue and service the data, as that device is available. Accordingly, as a result of processing the data using a shared input queue, the overall write rate to the RAID array may be increased over the slowest statistically possible worst-case write rate described above.

As used herein, a device may be available to service data (e.g., from the single input queue, or the like) when that device has available data processing resources. For example, if a device has available space in its internal data cache, then it may be available to service data. If a device is not performing maintenance (e.g., wear leveling, error correction, or the like) it may be available to service data. It is to be appreciated, that the examples given here for “when” a device may be available to service data are given for illustrative purposes only and are not intended to be limiting.

It is to be appreciated that this example is given for illustrative purposes only and is not intended to be limiting. Furthermore, although many example embodiments described herein refer to RAID configurations, some embodiments of the present disclosure may be applied to other types of multi-element storage arrays (e.g., JBOD arrays, or the like). Additionally, various examples of the present disclosure may be applied to different types of RAID configurations (e.g., RAID 0, RAID 1, RAID 0+1, RAID 1+0, RAID 2, RAID 3, RAID 4, RAID 5, RAID 5+3, RAID 6, or the like). No intention is made herein to limit the type of multi-element array, number of elements, or configuration based solely upon the examples provided herein.

Various examples of the present disclosure may refer to a data queue. It is to be appreciated, that various techniques for managing and scheduling a queue may be used. For example, some embodiments of the present disclosure may use fair queuing techniques. Other embodiments of the present disclosure may use round-robin queuing techniques. It is to be appreciated, that other queuing or scheduling techniques (e.g., first-in first-out or FIFO, last-in first-out or LIFO, fixed priority, circular buffer, or the like) may also be implemented according to various embodiments of the present disclosure.

Additionally, various examples of the present disclosure may refer to solid-state storage, solid-state storage devices, and SSDs. It is to be appreciated, that at least some embodiments described herein may use various types of solid-state technology (e.g., Flash, DRAM, phase-change memory, resistive RAM, ferroelectric RAM, nano-RAM, or the like). Furthermore, at least some embodiments of the present invention may be applicable to multi-element storage arrays where one or more of the elements may be non-SSD type storage devices. For example, with some embodiments, a RAID array may be comprised of a combination of spinning disk storage and SSD storage.

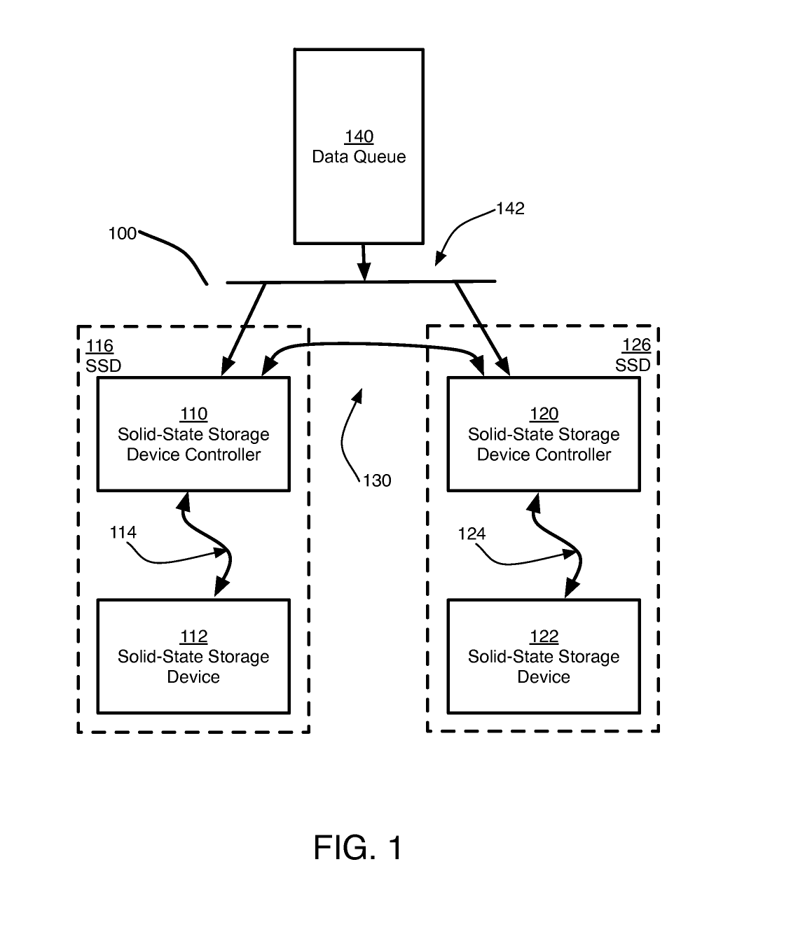

FIG. 1 illustrates a block diagram of an example solid-state storage device system 100, arranged in accordance with at least some embodiments of the present disclosure. As can be seen from this figure, the solid-state storage device system 100 may include a first solid-state storage device controller 110, and a corresponding first solid-state storage device 112. The solid-state storage device system 100 may also include a second solid-state storage device controller 120 as well as a corresponding second solid-state storage device 122.

The first solid-state storage device controller 110 may be communicatively coupled to the first solid-state storage device 112, via a first communication link 114. Similarly, the second solid-state storage device controller 120 may be communicatively coupled to the second solid-state storage device 122, via a second communication link 124. Furthermore, the first and second solid-state storage device controllers 110 and 120 may be communicatively coupled to each other via a third communication link 130. Additionally, the first and second solid-state storage device controllers 110 and 120 may include logic and/or features configured to control data transfer to and from the respective solid-state storage devices 112 and 122.

In general, the first and second solid-state storage device controller 110 and 120 may include logic and/or features configured to selectively write data to the first and second solid-state storage devices 112 and 122 from a single input data queue. For example, a data queue 140 is shown connected to the solid-state storage device controllers 110 and 120, via a common data bus 142. With some embodiments of the present disclosure, the data queue 140 may be a single queue. In an alternative example, the data queue 140 may be comprised of multiple queues that operate as a single queue. For example, multiple queues may be mapped the data queue 140. The queue 140 may be a separate unit or may be associated with one or more of controller 110 or 120.

In some embodiments of the present disclosure, the first and second solid-state device controllers 110 and 120 may be configured to signal each other, via the third communication link 130, of availability of the solid-state storage devices 112 and 122. As such, the first and second solid-state device controllers 110 and 120 may be configured to access data from the input data queue (e.g., the common data bus 142, the data queue 140, or the like), as their respective solid-state storage devices 112 and 122 are available. This data may then be written to the respective solid-state storage devices 112 and 122. With some embodiments of the present disclosure, the respective solid-state storage device controllers 110 and 120 may determine availability of the solid-state storage devices 112 and 122.

As the first and second solid-state device controllers 110 and 120 may signal each other of availability, data may be load balanced between the solid-state storage devices 112 and 122. For example, in some embodiments of the present disclosure, the solid-state storage device controllers 110 and 120 may track the amount of data processed from the data queue 140. The solid-state storage device controllers 110 and 120 may communicate the relative amount of data processed via the communication link 130. In an alternative example, the solid-state storage device controllers 110 and 120 may query each other, via the communication link 130, for the fill status. The solid-state storage device controllers 110 and 120 may then use the relative amount of data processed or the fill status to facilitate load balancing.

It is to be appreciated, that although the solid-state storage device controllers 110 and 120 are shown separately from the solid-state storage devices 112 and 122, with some embodiments, they may be provided in the same package or alternatively integrated together on a single device that includes substantially the same functionality. For example, the solid-state storage device controllers 110 and 120 as well as solid-state storage devices 112 and 122, respectively, are shown as being included within SSDs 116 and 126. In some example configurations, the SSDs 116 and 126 may be included in a multi-element storage array that is configured to process data from a shared bus (e.g., the communication link 130, the shared bus 142, or the like). More specifically, the SSDs 116 and 126 may be configured to service data input from a single input data queue (e.g., the data queue 140, or the like) as described above.

With some embodiments, the first, second, and third communication links 114, 124, and 130 may be any of a wide variety of digital data communications technologies, such as, but not limited to: non-volatile memory express (NVM Express), non-volatile memory host controller interface specification (NVMHCI), peripheral component interconnect express (PCI Express), serial advanced technology attachment (SATA), serial attachment small computer system interface (serial attachment SCSI), and Fibre Channel (FC).

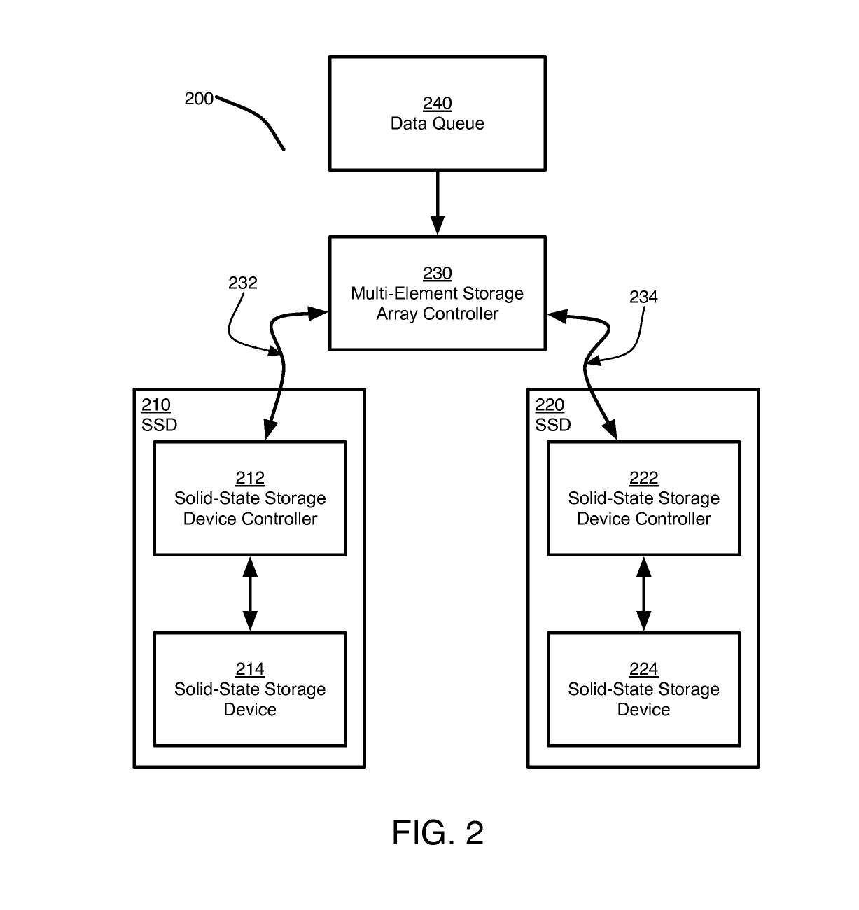

FIG. 2 illustrates a block diagram of another example solid-state storage device system 200, arranged in accordance with at least some embodiments described herein. As can be seen from this figure, the solid-state storage device system 200 may include a first SSD 210, a second SSD 220, and a multi-element storage array controller 230. FIG. 2 further shows that the first SSD 210 may include a solid-state storage device controller 212 and a corresponding solid-state storage device 214. Similarly, the second SSD 220 may include a solid-state storage device controller 222 and a corresponding solid-state storage device 224.

In general, the multi-element storage array controller 230 may include logic and/or features configured to send data from a data queue 240 to either of the SSDs 210 or 220, as they are available to receive data. As indicated above, a device (e.g., the SSD 210, the SSD 220, or the like) may be available to service data when that device has available data processing resources. Accordingly, with some embodiments of the present disclosure, the multi-element storage array controller 230 may be configured to determine which of the SSDs 210 or 220 are available and then send data form the data queue 240 to the available SSD.

In one example, each of the solid-state storage device controllers 212 and 222 may be configured to individually report (e.g., via the communication links 232 and 234 respectively) to the multi-element storage array controller 230 when a respective one of the SSDs 210 and 220 is available to write data. Since the SSD2 210 and 220 are now known to be available, the multi-element storage array controller 230 may then distribute data from the data queue 240 to either of the SSDs 210 and 220 such that the solid-state storage devices 214 and 224 can execute write operations.

In an alternative example, the SSDs 210 and 220 may be configured to individually signal (e.g., via communication links 232 and 234 respectively) the multi-element storage array controller 230 when they are unavailable to write data (e.g., due to a contention event, congestion event, or the like). The multi-element storage array controller 230 may then not send data to one or more of the unavailable SSD(s) 210 or 220 from the data queue 140, and instead only send data to those SSD devices that are presumed to still be available.

With some embodiments of the present disclosure, various load balancing activities may be facilitated by configuring the multi-element storage array controller 230 to track data delivered toSSD devices 210 and 220. Alternatively, the multi-element storage array controller 230 may be configured to facilitate load balancing by actively querying fill status of the solid-state storage devices and identifying available storage space.

In some embodiments of the present disclosure, the SSDs that are not currently scheduled (e.g., via the multi-element storage array controller 230) to receive data may be configured (e.g., by the multi-element storage array controller 230, by the solid-state storage device controllers 212 and 222, respectively, or the like) to perform solid-state storage maintenance (e.g., wear-leveling, error correction, or the like). For example, suppose the multi-element storage array controller 230 sent two blocks of data (e.g., from the data queue 140, or the like) to the SSD 210 and zero blocks of data (e.g., from the data queue 140, or the like) to the SSD 220 during the last distribution (e.g., due to the SSD 220 not be available, or the like). Then, the multi-element storage array controller 230 may not send any blocks of data to the SSD 210 during the next distribution, due to, for example, load leveling reasons. Accordingly, the SSD 210 may be able to perform some maintenance operations (e.g., wear leveling, or the like) when the SSD is not presently in use for other data operations such as read or write operations.

As indicated above, various embodiments of the present disclosure may be implemented using various multi-element storage array technologies. Accordingly, although FIGS. 1 and 2 only illustrate two SSDs (e.g., the SSDs 116 and 126), some embodiments may be implemented with more than two SSDs. For example, some embodiments of the present disclosure may be implemented with three SSDs in a RAID 5 configuration. Alternatively, with some embodiments of the present disclosure may be implemented with four SSDs in a RAID 1 configuration. It is to be appreciated that other combinations of SSDs and multi-element storage configurations are also possible within the spirit and scope of this disclosure.

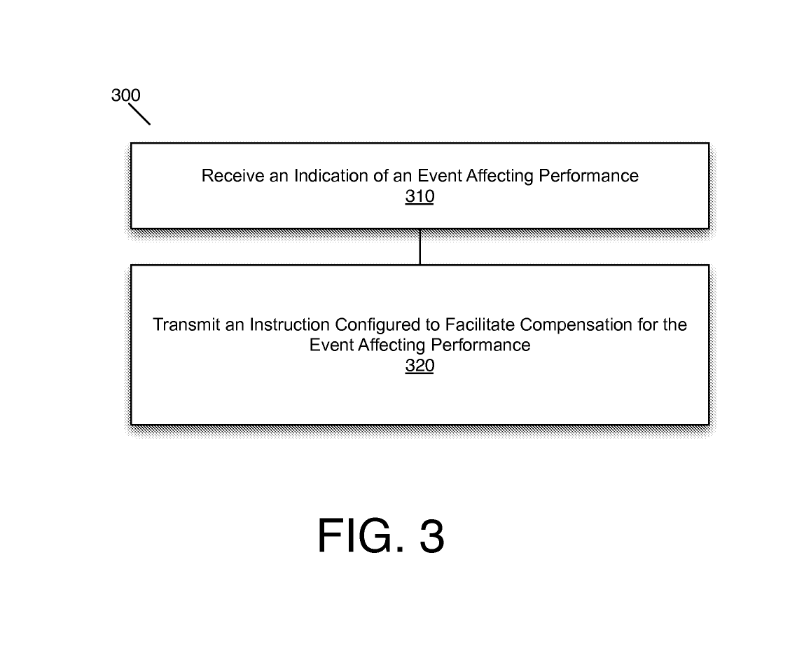

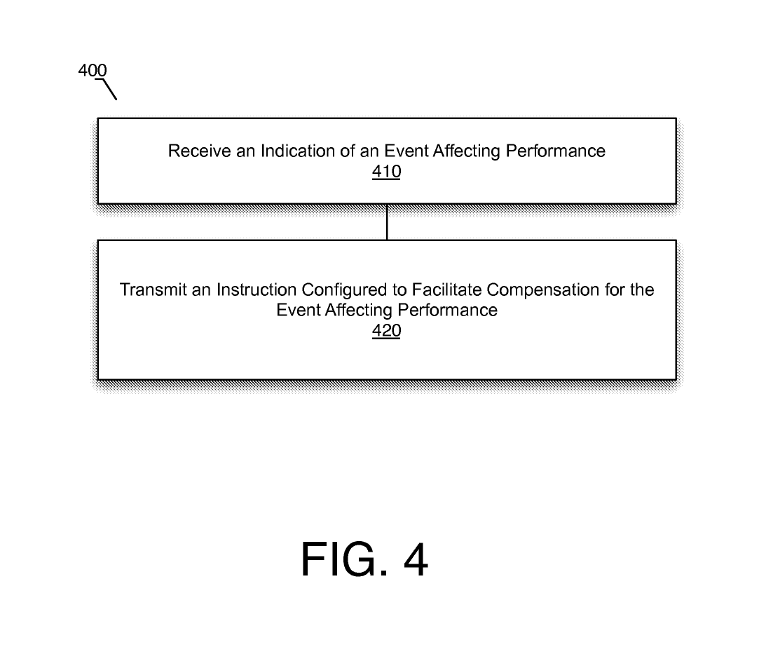

FIG. 3 illustrates a flow chart of an example method for managing writing data to a multi-element solid-state storage array, arranged in accordance with at least some embodiments of the present disclosure. Additionally, FIG. 4 illustrates a flow chart of another example method for managing writing data to a multi-element solid-state storage array, also arranged in accordance with at least some embodiments of the present disclosure. In some portions of the description, illustrative implementations of the methods depicted in FIGS. 3 and 4 may be described with reference to the elements of the solid-state storage device system 100 and the solid-state storage device system 200 depicted in FIGS. 1 and 2. However, the described embodiments are not limited to this depiction. More specifically, some elements depicted in FIGS. 1 and 2 may be omitted from some implementations of the methods detailed herein. Furthermore, other elements not depicted in FIGS. 1 and 2 may be used to implement example methods detailed herein.

Additionally, FIGS. 3 and 4 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated, modified, or split into multiple actions. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

FIG. 3 illustrates an example method 300 for managing writing data to a multi-element solid-state storage array, arranged in accordance with various embodiments of the present disclosure. Method 300 may begin at block 310 “Receive an Indication of an Event Affecting Performance,” a first solid-state storage device controller may receive an indication of an event affecting the performance of a first solid-state storage device. For example, the solid-state storage device controller 110 may include logic and/or features configured to receive an indication of an event affecting performance of the solid-state storage device 112. In general, at block 310, the solid-state storage device controller 110 may receive a notification signal (e.g., a communication via the first communication link 114) from the solid-state storage device 112, which indicates that the solid-state storage device 112 may be experiencing some event that affects the performance of the solid-state storage device 112. For example, if the solid-state storage device 112 is experiencing an event (e.g., contention, congestion, of the like), the solid-state storage device 112 may send a notification the solid-state storage device controller 110 of the event. As used herein, an indication may be any type of notification (e.g., a signal, a flag, an interrupt, or the like) capable of conveying the occurrence of an event affecting performance of a solid-state storage device.

Processing may continue from block 310 to block 320 “Transmit an Instruction Configured to Facilitate Compensation for the Event Affecting Performance,” the first solid-state storage device controller may transmit an instruction, configured to facilitate compensating for the event, to a second solid-state storage device controller. It is to be appreciated, that the instruction may not facilitate a “complete” (e.g., 100%, or the like) abatement of the effects of the event. Instead, the instruction may facilitate some compensatory measures, as described herein. In some embodiments of the present disclosure, the first solid-state storage device may transmit the instruction in response to receiving the indication at block 310. For example, the solid-state storage device controller 110 may include logic and/or features configured to transmit instructions to the solid-state storage device controller 120 (e.g., via the communication link 130, or the like). In general, at block 320, the SSD 116 may notify the SSD 126 that it is unavailable to process incoming data (e.g., due to the event, or the like). Accordingly, the SSD 126 may be configured to process incoming data in order to compensate for the SSD 116 being unavailable.

FIG. 4 illustrates an example method 400 for managing writing data to a multi-element solid-state storage array, arranged in accordance with various embodiments of the present disclosure. Method 400 may begin at block 410 “Receive an Indication of an Event Affecting Performance,” a memory control module may receive an indication of an event affecting performance of a first solid-state device. For example, the multi-element storage array controller 230 may include logic and/or features configured to receive an indication of an event affecting performance of the SSD 210. In general, at block 410, the multi-element storage array controller 230 may receive notification from the solid-state storage device controller 212 of an indication that the solid-state storage device 214 may be experiencing some event that affects the performance of the solid-state storage device 214. For example, if the solid-state storage device 214 is experiencing an event (e.g., contention, congestion, of the like), the solid-state storage device controller 212 may notify the multi-element storage array controller 230 of the event.

Processing may continue from block 410 to block 420 “Transmit an Instruction Configured to Facilitate Compensation for the Event Affecting Performance,” the memory control module may transmit an instruction, configured to facilitate compensating for the event affecting performance, to a second solid-state device. For example, the multi-element storage array controller 230 may include logic and/or features configured to transmit instructions to the SSD 220. In general, at block 420, the multi-element storage array controller 230 may be configured to instruct the SSD 220 to process data while the SSD 210 is unavailable.

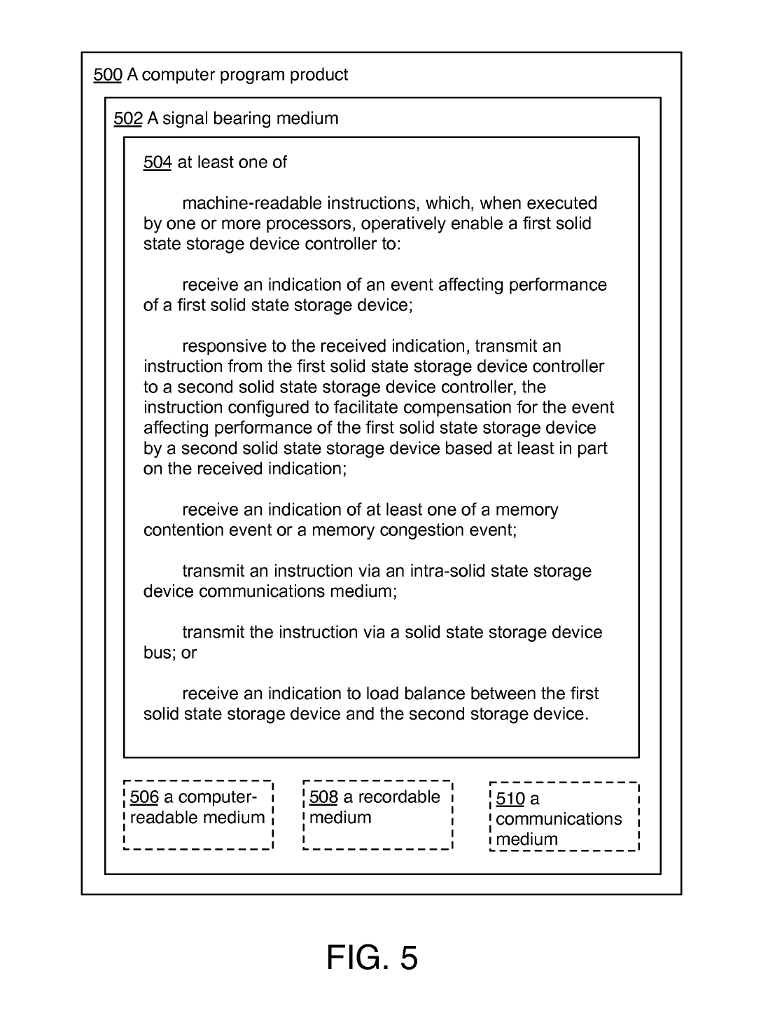

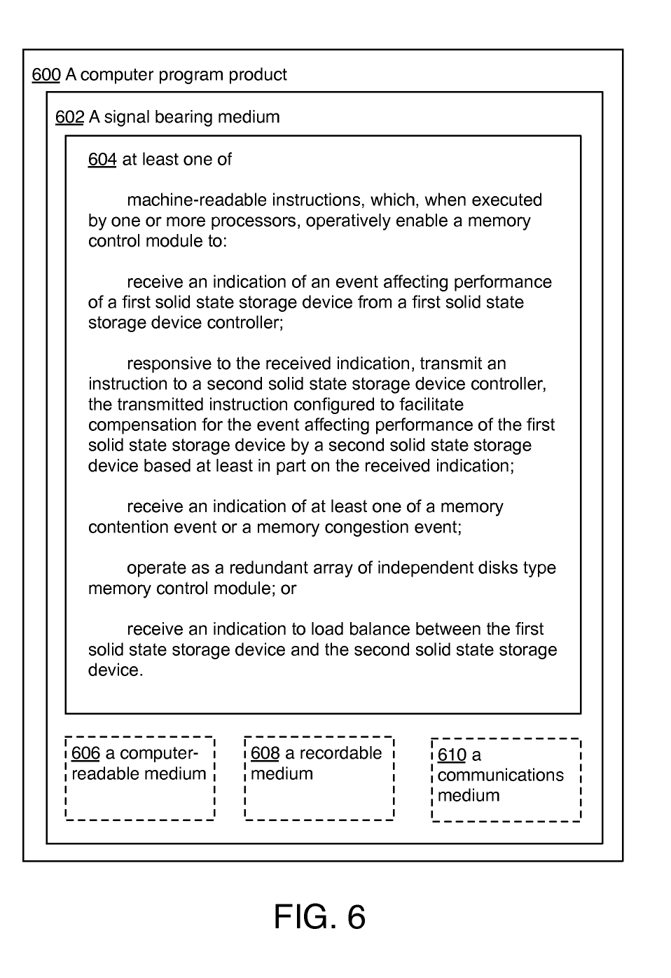

In general, the methods described with respect to FIGS. 3 and 4 and elsewhere herein may be implemented as a computer program product, executable on any suitable computing system, or the like. Example computer program products may be described with respect to FIGS. 5 and 6, and elsewhere herein.

FIG. 5 illustrates an example computer program product 500, arranged in accordance with at least some embodiments of the present disclosure. Computer program product 500 may include machine-readable non-transitory medium having stored therein instructions that, when executed, cause a first solid-state storage device controller to manage data in a multi-element storage array according to the processes and methods discussed herein. Computer program product 500 may include a signal bearing medium 502. Signal bearing medium 502 may include one or more machine-readable instructions 504, which, when executed by one or more processors, may operatively enable a computing device to provide the functionality described herein. In various examples, the devices discussed herein may use some or all of the machine-readable instructions.

In some examples, the machine-readable instructions 504 may include receiving an indication of an event affecting performance of a first solid-state storage device. In some examples, the machine-readable instructions 504 may include responsive to the received indication, transmitting an instruction from the first solid state storage device controller to a second solid state storage device controller, the instruction configured to facilitate compensation for the event affecting performance of the first solid state storage device by a second solid state storage device based at least in part on the received indication. In some examples, the machine-readable instructions 504 may include receiving an indication of at least one of a memory contention event or a memory congestion event. In some examples, the machine-readable instructions 504 may include transmitting an instruction via an intra-solid state storage device communications medium. In some examples, the machine-readable instructions 504 may include transmitting the instruction via a solid-state storage device bus. In some examples, the machine-readable instructions 504 may include receiving an indication to load balance between the first solid-state storage device and the second storage device.

In some implementations, signal bearing medium 502 may encompass a computer-readable medium 506, such as, but not limited to, a hard disk drive, a Compact Disc (CD), a Digital Versatile Disk (DVD), a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal-bearing medium 502 may encompass a machine-readable non-transitory medium.

FIG. 6 illustrates an example computer program product 600, arranged in accordance with at least some embodiments of the present disclosure. Computer program product 600 may include machine-readable non-transitory medium having stored therein instructions that, when executed, cause a memory control module to manage data in a multi-element storage array according to the processes and methods discussed herein. Computer program product 600 may include a signal bearing medium 602. Signal bearing medium 602 may include one or more machine-readable instructions 604, which, when executed by one or more processors, may operatively enable a computing device to provide the functionality described herein. In various examples, the devices discussed herein may use some or all of the machine-readable instructions.

In some examples, the machine-readable instructions 604 may include receiving an indication of an event affecting performance of a first solid-state storage device from a first solid-state storage device controller. In some examples, the machine-readable instructions 604 may include responsive to the received indication, transmitting an instruction to a second solid-state storage device controller, the transmitted instruction configured to facilitate compensation for the event affecting performance of the first solid-state storage device by a second solid-state storage device based at least in part on the received indication. In some examples, the machine-readable instructions 604 may include receiving an indication of at least one of a memory contention event or a memory congestion event. In some examples, the machine-readable instructions 604 may include operating as a redundant array of independent disks type memory control module. In some examples, the machine-readable instructions 604 may include receiving an indication to load balance between the first solid-state storage device and the second solid-state storage device.

In some implementations, signal bearing medium 602 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communication link, a wireless communication link, etc.). In some examples, the signal-bearing medium 602 may encompass a machine-readable non-transitory medium.

In general, the methods described with respect to FIGS. 3, 4 and elsewhere herein may be implemented in any suitable server and/or computing system. Example systems may be described with respect to FIGS. 3, 4 and elsewhere herein. In some examples, an SSD, a solid-state device controller, a multi-element storage array controller, a memory controller, or other system as discussed herein may be configured to control data input to a multi-element solid-state storage array.

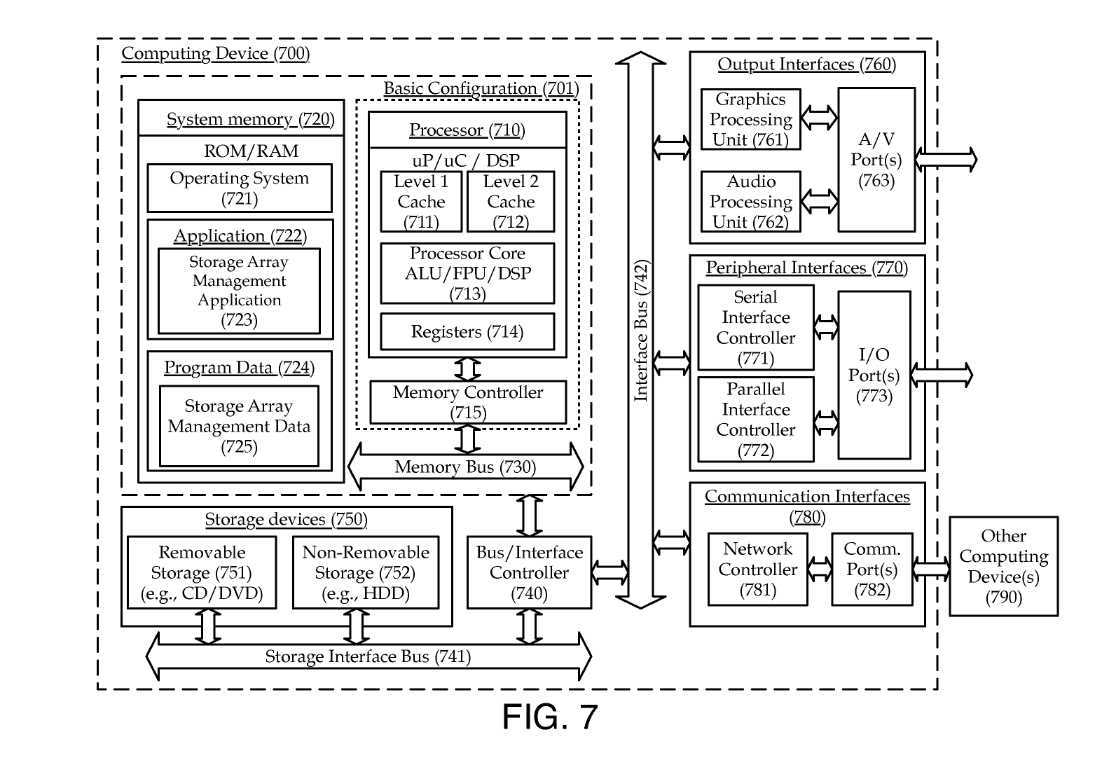

FIG. 7 is a block diagram illustrating an example computing device 700, arranged in accordance with at least some embodiments of the present disclosure. In various examples, computing device 700 may be configured to write data to an SSD as discussed herein. In various examples, computing device 700 may be configured to manage data in a multi-element storage array as discussed herein. In one example of a basic configuration 701, computing device 700 may include one or more processors 710 and a system memory 720. A memory bus 730 can be used for communicating between the one or more processors 710 and the system memory 720.

Depending on the desired configuration, the one or more processors 710 may be of any type including but not limited to a microprocessor (μP), a microcontroller (μC), a digital signal processor (DSP), or any combination thereof. The one or more processors 710 may include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the one or more processors 710, or in some implementations the memory controller 715 can be an internal part of the processor 710.

Depending on the desired configuration, the system memory 720 may be of any type including but not limited to volatile memory (such as RAM), non-volatile memory (such as ROM, flash memory, etc.) or any combination thereof. The system memory 720 may include an operating system 721, one or more applications 722, and program data 724. The one or more applications 722 may include storage array management application 723 that can be arranged to perform the functions, actions, and/or operations as described herein including any of the functional blocks, actions, and/or operations described with respect to FIGS. 1-6 herein. The program data 724 may include storage array management data 725 for use with storage array management application 723. In some example embodiments, the one or more applications 722 may be arranged to operate with the program data 724 on the operating system 721. This described basic configuration 701 is illustrated in FIG. 7 by those components within dashed line.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The one or more data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 720, the removable storage 751 and the non-removable storage 752 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 742 for facilitating communication from various interface devices (e.g., output interfaces, peripheral interfaces, and communication interfaces) to the basic configuration 701 via the bus/interface controller 740. Example output interfaces 760 may include a graphics processing unit 761 and an audio processing unit 762, which may be configured to communicate to various external devices such as a display or speakers via one or more AN ports 763. Example peripheral interfaces 770 may include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which may be arranged to facilitate communications with one or more other computing devices 783 over a network communication via one or more communication ports 782. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 700 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 700 may also be implemented as a personal computer including both laptop computer and non-laptop computer configurations. In addition, the computing device 700 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method for data storage management comprising:
at a first solid state storage device controller, receiving an indication of an event affecting performance of a first solid state storage device, wherein receiving the indication comprises receiving an indication of at least one of a memory contention event or a memory congestion event; and
responsive to the received indication, transmitting an instruction from the first solid state storage device controller to a second solid state storage device controller, the instruction configured to facilitate compensation for the event affecting performance of the first solid state storage device by a second solid state storage device based at least in part on the received indication.

2. (canceled)

3. The method of claim 1, wherein transmitting the instruction comprises transmitting the instruction via an intra-solid state storage device communications medium.

4. The method of claim 3, wherein the intra-solid state storage device communications medium comprises a solid state storage device bus.

5. The method of claim 1, wherein receiving the indication comprises receiving an indication to load balance between the first solid state storage device and the second solid state storage device.

6. A method for data storage management comprising:
at a memory control module, receiving an indication of an event affecting performance of a first solid state storage device from a first solid state storage device controller, wherein receiving the indication comprises receiving an indication of at least one of a memory contention event or a memory congestion event; and
responsive to the received indication, transmitting an instruction to a second solid state storage device controller, the transmitted instruction configured to facilitate compensation for the event affecting performance of the first solid state storage device by a second solid state storage device based at least in part on the received indication.

7. (canceled)

8. The method of claim 6, wherein the memory control module comprises a redundant array of independent disks type memory control module.

9. The method of claim 6, wherein receiving the indication comprises receiving an indication to load balance between the first solid state storage device and the second solid state storage device.

10.-18. (canceled)

19. A system comprising:
a first solid state storage device;
a first solid state storage device controller, the first solid state storage device controller communicatively coupled to the first solid state storage device;
a second solid state storage device; and
a second solid state storage device controller, the second solid state storage device controller communicatively coupled to the second solid state storage device and to the first solid state storage device controller, wherein the first solid state storage device controller is configured to:
receive an indication of an event that affects performance of the first solid state storage device, wherein the received indication includes an indication of at least one of a memory contention event or a memory congestion event; and
responsive to the received indication, transmit an instruction from the first solid state storage device controller to the second solid state storage device controller, the instruction configured to facilitate compensation for the event that affects performance of the first solid state storage device by the second solid state storage device based at least in part on the received indication.

20. (canceled)

21. The system of claim 19, wherein the first solid state storage device controller is configured to transmit the instruction via an intra-solid state storage device communications medium.

22. The system of claim 21, wherein the first solid state storage device controller is configured to transmit the instruction via a solid state storage device bus.

23. The system of claim 19, wherein the first solid state storage device controller is further configured to load balance between the first solid state storage device and the second storage device.

24. A system comprising:
a first solid state storage device;
a first solid state storage device controller, the first solid state storage device controller communicatively coupled to the first solid state storage device;
a second solid state storage device;
a second solid state storage device controller, the second solid state storage device controller communicatively coupled to the second solid state storage device and to the first solid state storage device controller; and
a memory control module coupled to the first solid state storage device controller and a second solid state storage device controller, the memory control module being configured to:
receive an indication of an event that affects performance of the first solid state storage device from the first solid state storage device controller, wherein the received indication includes an indication of at least one of a memory contention event or a memory congestion event; and
responsive to the received indication, transmit an instruction to the second solid state storage device controller, the transmitted instruction configured to facilitate compensation for the event that affects performance of the first solid state storage device by the second solid state storage device based at least in part on the received indication.

25. (canceled)

26. The system of claim 24, wherein the memory control module is further configured to operate as a redundant array of independent disks type memory control module.

27. The system of claim 24, wherein the memory control module is further configured to load balance between the first solid state storage device and the second solid state storage device.
